(19) United States
(12) Patent Application Publication
(10) Pub. No.: US 2018/0118202 A1
(43) Pub. Date: May 3, 2018

(54) VEHICLE CONTROL APPARATUS AND VEHICLE CONTROL METHOD

(71) Applicants: DENSO CORPORATION, Kariya-city, Aichi-pref. (JP); TOYOTA JIDOSHA KABUSHIKI KAISHA, Toyota-shi, Aichi-ken (JP)

(72) Inventors: Naotsugu Shimizu, Kariya-city, Aichi-pref. (JP); Toru Takahashi, Kariya-city, Aichi-pref. (JP); Jun Tsuchida, Okazaki-shi, Aichi-ken (JP); Masayuki Shimizu, Numazu-shi, Shizuoka-ken (JP)

(21) Appl. No.: 15/562,284

(22) PCT Filed: Mar. 29, 2016
(86) PCT No.: PCT/JP2016/060111

§ 371 Date: Sep. 27, 2017

(30) Foreign Application Priority Data
Mar. 31, 2015 (JP) 2015-072922

(51) Int. Cl. B60W 30/09; B60W 10/18; B60W 10/20; B60W 50/14; G08G 1/16

(52) U.S. Cl. CPC B60W 30/09; B60W 10/18; B60W 10/20; B60W 50/14; G08G 1/166; B60W 2550/10; B60W 2510/205; B60W 2540/18; B60W 2520/10; B60W 2520/14; B60W 2510/18

(57) ABSTRACT

A vehicle control apparatus acquires a relative position of an object to an own vehicle, the object being located ahead of the own vehicle in a traveling direction. The vehicle control apparatus acquires yaw rate information including at least one value of a yaw rate and a yaw rate differential value of the own vehicle. The vehicle control apparatus acquires steering information including at least one value of a steering angle and a steering angle speed of the own vehicle. The vehicle control apparatus activates, on a basis of the relative position, a safety unit for avoiding a collision with the object. In the case where an absolute value of the yaw rate information is greater than a first threshold and an absolute value of the steering information is greater than a second threshold, the vehicle control apparatus causes the safety unit to be less likely to be activated.

### TECHNICAL FIELD

The present disclosure relates to a vehicle control technique of determining whether there is a possibility of collision between an own vehicle and an object existing ahead of a travelling direction of the own vehicle.

### BACKGROUND ART

Pre-crash safety (PCS) has been conventionally realized which reduces or prevents damage of a collision between an own vehicle and an object, such as another vehicle, a pedestrian, or a road structure, which is located ahead of a traveling direction of the own vehicle. According to PCS, time to collision (TTC) which is a time until an own vehicle collides with an object is calculated on the basis of a relative distance between the own vehicle and the object and a relative speed or a relative acceleration between the own vehicle and the object. According to the PCS, on the basis of the time to collision (TTC) thus calculated, a driver of the own vehicle is notified by a notification unit or the like that the own vehicle is approaching the object, or a braking unit of the own vehicle is activated.

According to the PCS, control is performed on the basis of a position of an object located ahead of the own vehicle. Accordingly, in the case where the own vehicle is in a turning state, even if an object is located ahead of the own vehicle, the object may not be present on a traveling course of the own vehicle.

In regard to this, according to a driving assist apparatus disclosed in Patent Literature 1, in the case where a yaw rate differential value which is a time differential value of a detected yaw rate is not less than a threshold, it is determined that a steering operation (steering angle increasing operation) by a driver has been performed. In this case, according to the driving assist apparatus of Patent Literature 1, it is less likely to be determined that an object is highly likely to collide with an own vehicle.

### CITATION LIST

### Patent Literature

PTL 1: JP 2014-222463 A

### SUMMARY OF THE INVENTION

### Technical Problem

In the case where, for example, a braking unit of a vehicle has been activated, there is a problem of erroneous detection of a yaw rate differential value occurs. The problem arises because, for example, in the case where automatic braking has been activated by a braking unit, the automatic braking changes a value of a yaw rate. In such a case, if a yaw rate differential value is not less than a threshold, there is a possibility that it is determined that a driver has performed a steering operation, and the automatic braking is released.

An object of the present disclosure is to provide a vehicle control apparatus and a vehicle control method each of which is capable of accurately controlling a safety unit which is provided in an own vehicle.

### Solution to Problem

A vehicle control apparatus of the present disclosure includes a position acquisition means, a yaw rate information acquisition means, a steering information acquisition means, and an avoidance control means. The position acquisition means acquires a relative position of an object to an own vehicle, the object being located ahead of the own vehicle in a traveling direction. The yaw rate information acquisition means acquires yaw rate information including at least one value of a yaw rate of the own vehicle and a yaw rate differential value which is a time differential value of the yaw rate. The steering information acquisition means acquires steering information including at least one value of a steering angle of the own vehicle and a steering angle speed which is a time differential value of the steering angle. The avoidance control means activates, on a basis of the relative position, a safety unit for avoiding a collision with the object, the safety unit being provided in the own vehicle, in the case where an absolute value of the yaw rate information is greater than a first threshold and an absolute value of the steering information is greater than a second threshold, the avoidance control means causing the safety unit to be less likely to be activated.

In the case where one of yaw rate information and steering information is used to determine whether there is a possibility that an own vehicle will collide with an object which is located ahead of the own vehicle in a traveling direction, the determination may be erroneous. In the case where the yaw rate information is used, it may be erroneously detected, due to behavior of the vehicle or the like, that the own vehicle is in a turning state even though the own vehicle is in a straight traveling state. Meanwhile, in the case where the steering information is used, it may be erroneously detected, due to displacement of a steering unit or the like, that the own vehicle is in the turning state even though the own vehicle is in the straight traveling state. Thus, according to the vehicle control apparatus of the present disclosure, in the case where a value of the yaw rate information is greater than the first threshold and a value of the steering information is greater than the second threshold, the safety unit is less likely to be activated. This allows the vehicle control apparatus of the present disclosure to increase accuracy in determination of whether to activate the safety unit.

### BRIEF DESCRIPTION OF THE DRAWINGS

FIG. 1 is an overall configuration diagram of a vehicle control apparatus.

FIG. 2 is a view illustrating a determination region based on a limiting value of a first embodiment.

FIG. 3 is a view illustrating a limiting value in the case where an own vehicle is in a turning state.

FIG. 4 is a flow chart showing a process of the first embodiment.

FIG. 5 is a view illustrating a collision lateral position.

### DESCRIPTION OF THE EMBODIMENTS

The following description will discuss embodiments with reference to drawings. In the following embodiments, the same or equivalent parts are given the same reference numerals in figures and descriptions of the parts given the same reference numerals are cited.

### First Embodiment

A vehicle control apparatus in accordance with the present embodiment is provided in a vehicle (own vehicle) and detects an object which is present ahead of the own vehicle. The vehicle control apparatus then performs control for avoiding a collision between the object thus detected and the own vehicle or reducing collision damage. Thus, the vehicle control apparatus in accordance with the present embodiment functions as a pre-crash safety (PCS) system.

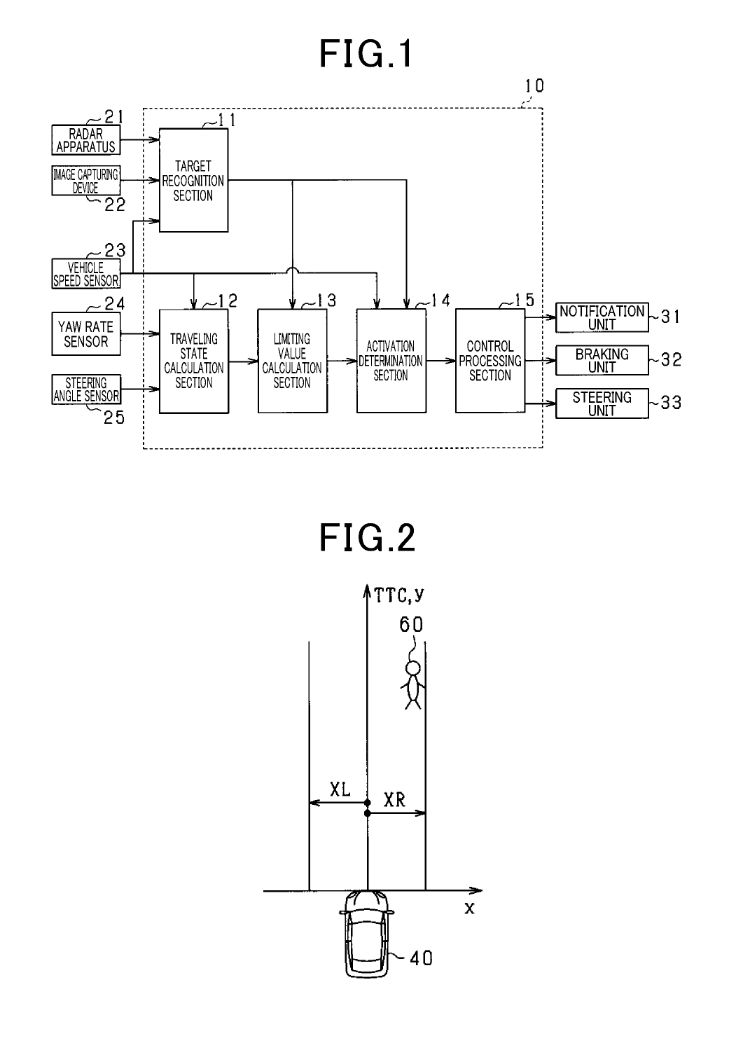

FIG. 1 is an overall configuration diagram of the vehicle control apparatus in accordance with the present embodiment. As illustrated in FIG. 1, a driving assist ECU 10 which is the vehicle control apparatus in accordance with the present embodiment is a computer including a CPU, a ROM, a RAM, I/O, and the like. The driving assist ECU 10 includes functions which are an object recognition section 11, a traveling state calculation section 12, a limiting value calculation section 13, an activation determination section 14, and a control processing section 15. According to the driving assist ECU 10, the CPU executes a program stored in the ROM so that each of the functions is realized.

A sensor device which inputs various types of detection information is connected to the driving assist ECU 10. Examples of the sensor device to be connected to the driving assist ECU 10 include a radar apparatus 21, an image capturing device 22, a vehicle speed sensor 23, a yaw rate sensor 24, and a steering angle sensor 25.

The radar apparatus 21 is, for example, a millimeter wave radar which transmits, as probe waves, a high frequency signal in a millimeter wave band. The radar apparatus 21 is provided in a front end of the own vehicle. The radar apparatus 21 considers, as a detectable region for an object, a region extending over a predetermined angular range, and detects a position of the object in the detectable region. Specifically, the radar apparatus 21 transmits probe waves at a predetermined control cycle and receives reflection waves via each of a plurality of antennas. On the basis of a transmission time of the probe waves and a reception time of the reflection waves, the radar apparatus 21 calculates a distance to the object which has reflected the probe waves. A frequency of the reflection waves reflected by the object is changed due to a Doppler effect. Accordingly, on the basis of the changed frequency of the reflection waves, the radar apparatus 21 calculates a relative speed to the object which has reflected the probe waves. The radar apparatus 21 further calculates cardinal points of the object which has reflected the probe waves, on the basis of a phase difference of the reflection waves received via the plurality of antenna. In the case where the position and the cardinal points of the object can be calculated, it is possible to specify a relative position of the object to the own vehicle. The radar apparatus 21 performs, for each predetermined control cycle, transmission of an probe waves, reception of a reflection waves, and calculation of a relative position and a relative speed of the object to the own vehicle. The radar apparatus 21 then transmits, to the driving assist ECU 10, the calculated relative position and relative speed per unit time.

The image capturing device 22 is, for example, a CCD camera, a CMOS image sensor, a near infrared camera, or the like. The image capturing device 22 is provided at a predetermined height in a center of a vehicle width direction of the own vehicle. The image capturing device 22 captures, from a bird's-eye view, an image of a region extending over a predetermined angular range toward ahead of the own vehicle. The image capturing device 22 extracts, in the captured image, a feature point indicating presence of an object. Specifically, the image capturing device 22 extracts edge points on the basis of brightness information of the captured image, and performs a Hough Transform with respect to the edge points thus extracted. In the Hough Transform, for example, a point on a straight line on which a plurality of edge points are continuously arranged or a point at which straight lines intersect with each other is extracted as a feature point. The image capturing device 22 captures an image and extracts a feature point for each control cycle which is the same as or different from that of the radar apparatus 21. The image capturing device 22 then transmits a result of the extraction of the feature point to the driving assist ECU 10.

The vehicle speed sensor 23 is provided on a rotating shaft which transmits power to wheels of the own vehicle. The vehicle speed sensor 23 detects a speed of the own vehicle on the basis of the number of rotations of the rotating shaft.

The yaw rate sensor 24 detects, as a yaw rate, a rotational angular speed around a vertical line passing through the center of gravity of the own vehicle. Accordingly, in the case where the own vehicle is in a straight traveling state, a detection value of the yaw rate is zero. In the case where the own vehicle is in a turning state, a turning direction (left or right direction) can be determined by a positive/negative sign (a sign indicating a displacement direction of the yaw rate) of the detection value.

The steering angle sensor 25 detects a steering angle which is obtained when a traveling course of the own vehicle has been controlled in accordance with a steering operation. Accordingly, in the case where no steering operation has been performed, a detection value of the steering angle is zero. In the case where a steering operation has been performed, a steering direction (left or right direction) can be determined by a positive/negative sign of the detection value.

The driving assist ECU 10 is connected to various safety units each of which is driven by a control command provided from the driving assist ECU 10. Examples of the safety units to be connected to the driving assist ECU 10 include a notification unit 31, a braking unit 32, and a steering unit 33.

The notification unit 31 is, for example, a speaker, a display, or the like which is provided in a cabin of the own vehicle. In the case where the driving assist ECU 10 has determined that there is a possibility that the own vehicle will collide with an obstacle, the notification unit 31 notifies a driver of a collision risk by outputting an alarm sound, an alarm message, or the like, on the basis of a control command provided from the driving assist ECU 10.

The braking unit 32 is a braking unit which performs braking of the own vehicle. In the case where the driving assist ECU 10 has determined that there is a possibility that the own vehicle will collide with an obstacle, the braking unit 32 is activated on the basis of a control command provided from the driving assist ECU 10. Specifically, the braking unit 32 increases a braking force which is generated in response to a braking operation by the driver, or in the case where the driver has not performed a braking operation, the braking unit 32 performs automatic braking. That is, the braking unit 32 provides the driver with a brake assist function and an automatic brake function.

The steering unit 33 is a control device which controls a traveling course of the own vehicle. In the case where the driving assist ECU 10 has determined that there is a possibility that the own vehicle will collide with an obstacle, the steering unit 33 is activated on the basis of a control command provided from the driving assist ECU 10. Specifically, the steering unit 33 assists an avoidance steering operation by the driver, or in the case where the driver has not performed an avoidance steering operation, the steering unit 33 performs automatic steering. That is, the steering unit 33 provides the driver with an avoidance steering assist function or an automatic steering function.

The object recognition section 11 of the driving assist ECU 10 will be described below. The object recognition section 11 in accordance with the present embodiment functions as position acquisition means. The object recognition section 11 acquires, as first detection information, detection information (a result of the calculation of the position) detected by the radar apparatus 21. The object recognition section 11 acquires, as second detection information, detection information (a result of the extraction of the feature points) detected by the image capturing device 22. The object recognition section 11 then associates, in the following manner, first position information which is indicated by the position acquired from the first detection information with second position information which is indicated by the feature points acquired from the second detection information. That is, the object recognition section 11 associates, as position information of a single object, first position information and second position information which indicate respective positions close to each other.

The object recognition section 11 performs pattern matching with respect to the object for which the first position information and the second position information have been associated. Specifically, the object recognition section 11 performs pattern matching with respect to the second detection information with use of pattern data which has been prepared in advance for each of conceivable types of object. The object recognition section 11 then determines, on the basis of a result of the pattern matching, whether the detected object is a vehicle or a pedestrian (passerby), and associates, as a type of object, a result of the determination with the object. According to the present embodiment, a concept of the passerby which is one of the types of object can include a bicycle rider. Furthermore, the types of object can include an animal or the like, other than the vehicle and the passerby.

Subsequently, the object recognition section 11 associates, with the object of which type has been determined, a relative position and a relative speed of the object to the own vehicle. The relative position to be associated with the object includes a longitudinal position which is a relative position in the traveling direction of the own vehicle and a lateral position which is a relative position in a direction orthogonal to the traveling direction. The object recognition section 11 calculates, on the basis of the relative position and the relative speed, a longitudinal speed which is a relative speed in the traveling direction of the own vehicle and a lateral speed which is a relative speed in the direction orthogonal to the traveling direction.

The object recognition section 11 further identifies the type of object in accordance with a result of the determination of whether the object is a vehicle or a pedestrian and with the longitudinal speed and the lateral speed.

For example, when a type of the target is determined to be a vehicle, a type of the vehicle can be further identified as below. That is, the target recognition section 11 identifies four types of vehicle based on the longitudinal speed and the lateral speed. Specifically, the target recognition section 11 identifies a preceding vehicle traveling ahead of the own vehicle in the traveling direction of the own vehicle and an oncoming vehicle traveling ahead of the own vehicle in the traveling direction toward a direction opposite to the traveling direction of the own vehicle (traveling in an opposite lane). Furthermore, the target recognition section 11 identifies a stationary vehicle (a stopped vehicle or a parked vehicle) which stands still ahead of the own vehicle in the traveling direction and a crossing vehicle passing across ahead of the own vehicle in the traveling direction.

When a type of the target is determined to be a pedestrian, a type of the pedestrian can be further identified as below. That is, the target recognition section 11 identifies four types of pedestrian based on the longitudinal speed and the lateral speed. Specifically, the target recognition section 11 identifies a preceding pedestrian who is walking ahead of the own vehicle in the traveling direction of the own vehicle and an oncoming pedestrian who is walking ahead of the own vehicle in a direction opposite to the traveling direction of the own vehicle. Furthermore, the target recognition section 11 identifies a stationary pedestrian who stands still ahead of the own vehicle in the traveling direction and a crossing pedestrian who is passing across ahead of the own vehicle in the traveling direction.

In regard to a target which has been detected only based on the first detection information, a type of the target can be further identified as below. That is, the target recognition section 11 identifies four types of target based on the longitudinal speed and the lateral speed. Specifically, the target recognition section 11 identifies a preceding target moving ahead of the own vehicle in the traveling direction of the own vehicle and an oncoming target moving ahead of the own vehicle in traveling direction toward a direction opposite to the traveling direction of the own vehicle. Furthermore, the target recognition section 11 identifies a stationary target which stands still ahead of the own vehicle in the traveling direction and a crossing target passing across ahead of the own vehicle in the traveling direction.

With reference to FIG. 2, the following description will discuss the activation determination section 14 of the driving assist ECU 10. Specifically, the following description will discuss a determination process (a determination process for determining whether to activate the safety unit) which is performed by the activation determination section 14. For simplification of the description, FIG. 2 includes an x-axis indicating a position (a lateral position) in a lateral direction orthogonal to a traveling direction of an own vehicle 40 and a y-axis indicating a position (a longitudinal position) in the traveling direction (a longitudinal direction). The activation determination section 14 sets a rightward limiting value XR and a leftward limiting value XL in the lateral direction orthogonal to the traveling direction of the own vehicle 40 such that the rightward limiting value XR indicates a rightward width extending from a center axis of the own vehicle 40 to a right side when facing ahead of the own vehicle 40 in the traveling direction and the leftward limiting value XL indicates a leftward width extending from the center axis of the own vehicle 40 to a left side when facing ahead of the vehicle 40 in the traveling direction. The rightward limiting value XR and the leftward limiting value XL are values which have been determined in advance for each type of object 60. Accordingly, the activation determination section 14 sets the rightward limiting value XR and the leftward limiting value XL on the basis of a type of the object 60. For example, in the case where the type of the object 60 is a preceding vehicle, there is no possibility that the object 60 suddenly moves in the lateral direction, and thus, the activation determination section 14 sets the rightward limiting value XR and the leftward limiting value XL to values smaller than values to be set in the case where there is a possibility that the object 60 may suddenly move in the lateral direction. Meanwhile, in the case where the type of the object 60 is a pedestrian, there is a possibility that the object 60 may suddenly move in the lateral direction, and thus, the activation determination section 14 sets the rightward limiting value XR and the leftward limiting value XL to values greater than values to be set in the case where there is no possibility that the object 60 suddenly moves in the lateral direction. By using the rightward limiting value XR and the leftward limiting value XL which have been thus set, the activation determination section 14 sets, ahead of the traveling direction (on a traveling course) of the own vehicle 40, a determination region that has a rightward width on the basis of the rightward limiting value XR and has a leftward width on the basis of the leftward limiting value XL. Thus, the activation determination section 14 sets a region for determining whether the object 60 is present on the traveling course of the own vehicle 40. The rightward limiting value XR and the leftward limiting value XL are each acquired as a reference value (an initial value) of a limiting value by the limiting value calculation section 13. The limiting value calculation section 13 calculates a limiting value indicating a width in the lateral direction ahead of the traveling direction of the own vehicle 40. The activation determination section 14 then functions as presence determination means. On the basis of a lateral position of the object 60 and the determination region (limiting value) which has been set, the activation determination section 14 determines whether the object 60 is present on the traveling course of the own vehicle 40. In the case where the lateral position of the object 60 is inside the determination region (within a range of the limiting value), the activation determination section 14 determines that the object 60 is present on the traveling course of the own vehicle 40. Meanwhile, in the case where the lateral position of the object 60 is outside the determination region (outside the range of the limiting value), the activation determination section 14 determines that the object 60 is not present on the traveling course of the own vehicle 40.

The activation determination section 14 determines whether to activate the safety unit, on the basis of an activation timing and time to collision (TTC). Furthermore, the activation determination section 14 functions as collision time prediction means. On the basis of the longitudinal speed and the longitudinal position which have been acquired from the object recognition section 11, the activation determination section 14 calculates time to collision (TTC) which is time until the own vehicle 40 collides with the object 60. The time to collision (TTC) can be also calculated with use of a relative acceleration instead of the longitudinal speed.

The activation timing is set for each safety unit. Specifically, an earliest activation timing is set for the notification unit 31 among the safety units. This is because if the driver notices a collision risk by being notified by the notification unit 31 and depresses a brake pedal, a collision can be avoided without a control command provided from the driving assist ECU 10 to the braking unit 32. In regard to the braking unit 32, the activation timing is set for each of the brake assist function and the automatic brake function of the braking unit 32. The same applies to the steering unit 33. The activation timings of the braking unit 32 and the steering unit 33 can be the same values or different values.

According to the present embodiment, the activation timings are set as described above. Accordingly, in the case where the own vehicle 40 and the object 60 approach each other, so that time to collision (TTC) becomes short, the time to collision (TTC) is first the activation timing of the notification unit 31. When the activation determination section 14 and the control processing section 15 perform a process for activating the safety unit for which the activation timing has been set, the activation determination section 14 and the control processing section 15 function in cooperation as avoidance control means. In this case, the activation determination section 14 transmits an activation determination signal for the notification unit 31 to the control processing section 15. Consequently, on the basis of the received activation determination signal, the control processing section 15 transmits a control command signal to the notification unit 31. This causes the notification unit 31 to be activated to notify the driver of a collision risk. That is, in the case where the time to collision (TTC) has reached the activation timing of the safety unit, the activation determination section 14 determines to activate the safety unit. Meanwhile, in the case where the time to collision (TTC) has not reached the activation timing of the safety unit, the activation determination section 14 determines not to activate the safety unit.

In the case where the own vehicle 40 and the target 60 further approach each other so that the time to collision (TTC) further becomes shorter while the driver is not depressing the brake pedal after the notification unit 31 has been activated, the time to collision (TTC) is the timing of activation of the automatic brake function of the braking unit 32. In this case, the activation determination section 14 transmits an activation determination signal for the automatic brake function to the control processing section 15. As a result, on the basis of the received activation determination signal, the control processing section 15 transmits a control command signal for the automatic brake function to the braking unit 32. This causes the automatic brake function of the braking unit 32 to be activated to control braking of the own vehicle 40.

In the case where the time to collision (TTC) further becomes shorter while the driver is depressing the brake pedal, the time to collision (TTC) is the activation timing for the brake assist function of the braking unit 32. In this case, the activation determination section 14 transmits an activation determination signal for the brake assist function to the control processing section 15. As a result, on the basis of the received activation determination signal, the control processing section 15 transmits a control command signal for the brake assist function to the braking unit 32. This causes the brake assist function of the braking unit 32 to be activated to perform control of increasing a braking force with respect to a depression amount of the brake pedal by the driver.

In the case where a relative speed between the own vehicle 40 and the object 60 is great, it may be difficult to avoid a collision between the own vehicle 40 and the object 60 by control of the braking unit 32. In such a case, the steering unit 33 is automatically activated so that a collision is avoided. In the case where the driver has performed a steering operation but the object 60 is located inside the determination region (within the range of the limiting value), the steering operation by the driver is assisted so that a collision is avoided.

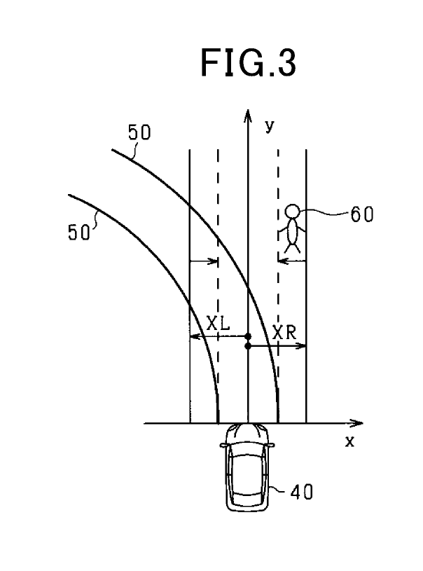

In order to accurately determine, with use of the limiting value described above, whether the object 60 is present on the traveling course of the own vehicle 40, it is important to determine whether the own vehicle 40 is traveling straight or turning. With reference to FIG. 3, the following description will discuss a positional relationship between the limiting value and the object 60 in the case where the own vehicle 40 is traveling in a curved section of a road (e.g., a curved road etc.) and is in the turning state.

As illustrated in FIG. 3, a road 50 on which the own vehicle 40 travels is a curved section. The object 60 is located outside the road 50 which is the curved section. In FIG. 3, the determination region which has been set on the basis of the rightward limiting value XR and the leftward limiting value XL (region for determining whether the object 60 is present on the traveling course of the own vehicle 40) is indicated by a solid line. In this case, the object 60 is located inside the determination region (within the range of the limiting value). It is therefore determined that the object 60 is present on the traveling course of the own vehicle 40. Consequently, on the basis of time to collision (TTC) which is time until the own vehicle 40 collides with the object 60, the driving assist ECU 10 activates the safety unit. As described above, however, the object 60 is present outside the road 50 which is the curved section and is not actually present on the traveling course of the own vehicle 40. Therefore, in the case where the safety unit is activated in order to avoid a collision with the object 60, the activation is an unnecessary activation (a condition in which a safety unit is activated when the safety unit does not need to be activated).

Thus, according to the present embodiment, the traveling state calculation section 12 of the driving assist ECU 10 determines whether the own vehicle 40 is turning (whether the own vehicle 40 is in the turning state). As a result, according to the present embodiment, in the case where the own vehicle 40 is in the turning state, the limiting value calculation section 13 of the driving assist ECU 10 calculates a corrected limiting value which is a value smaller than a normal limiting value (rightward limiting value XR and leftward limiting value XL) which is a reference value obtained as a determination criterion, and then sets the corrected limiting value as a limiting value which has been corrected. In this case, the limiting value calculation section 13 supplies, to the activation determination section 14, the corrected limiting value thus calculated and instructs the activation determination section 14 to newly set a limiting value. Upon receipt of the instruction, the activation determination section 14 newly sets a limiting value for the determination region on the basis of the corrected limiting value which has been supplied. As described above, in the case where the own vehicle 40 is in the turning state, the driving assist ECU 10 in accordance with the present embodiment performs a process in which the limiting value is set to a smaller value so that a width in a lateral direction of the determination region is narrowed. Thus, according to the driving assist ECU 10 in accordance with the present embodiment, the object 60 which is present outside the road 50 which is the curved section and on which the own vehicle 40 travels is caused not to be located (or to be less likely to be located) in the determination region. That is, the driving assist ECU 10 in accordance with the present embodiment performs control so that the object 60 which is present outside the road 50 which is the curved section and on which the own vehicle 40 travels is not determined (is less likely to be determined) to be present on the traveling course of the own vehicle 40. In FIG. 3, the determination region which has been set on the basis of the corrected limiting value is shown by a dashed line. By performing the control in this manner, the object 60 which is present outside the road 50 which is the curved section and on which the own vehicle 40 travels is caused to be located outside the determination region. Consequently, according to the driving assist ECU 10 in accordance with the present embodiment, the object 60 which is present outside the road 50 which is a curved section and on which the own vehicle 40 travels is determined not to be present on the traveling course of the own vehicle 40. This makes it possible to suppress unnecessary activation of the safety unit in the case where the own vehicle 40 is in the turning state.

According to the present embodiment, the determination of whether the own vehicle 40 is turning is made on the basis of a yaw rate differential value which is a value obtained by time-differentiating a yaw rate which is a detection value detected by the yaw rate sensor 24. In this case, the traveling state calculation section 12 functions as yaw rate information acquisition means (first acquisition means). Specifically, the traveling state calculation section 12 calculates a yaw rate differential value by time-differentiating a yaw rate which is a detection value detected by the yaw rate sensor 24, and acquires, as yaw rate information, the yaw rate differential value thus calculated. The traveling state calculation section 12 determines, on the basis of the yaw rate information thus acquired and a predetermined threshold (determination criterion value), whether the own vehicle 40 is turning. In the case where an absolute value of the yaw rate differential value is not less than a first threshold, the traveling state calculation section 12 determines that the own vehicle 40 has started turning (is in the turning state). Consequently, the activation determination section 14 sets, as the limiting value for the determination region, the corrected limiting value which is a value smaller than the normal limiting value, and then the value thus set is maintained. Meanwhile, in the case where, from this state, the absolute value of the yaw rate differential value becomes not less than the first threshold again and a sign of the yaw rate differential value is opposite to that of the yaw rate differential value when the traveling state calculation section 12 has determined that the turning state has started, the traveling state calculation section 12 determines that the own vehicle 40 has become in the straight traveling state. Consequently, the activation determination section 14 sets, as the limiting value for the determination region, the corrected limiting value back to the normal limiting value.

In the case where the yaw rate differential value is thus used to determine whether the own vehicle 40 is in the turning state, depending on behavior of the vehicle or the like, the yaw rate may be changed even though the own vehicle 40 is not in the turning state. For example, in the case where the time to collision (TTC) which is time until the own vehicle 40 collides with the object 60 becomes short and the automatic brake control function of the braking unit 32 has been activated, the yaw rate may be changed by a difference in braking forces of wheels. A phenomenon in which a yaw rate is thus changed by behavior of the vehicle or the like is noticeable in a vehicle whose centroid position is high. In this case, according to the driving assist ECU 10, if the absolute value of the yaw rate differential value becomes not less than the first threshold and the driving assist ECU 10 performs a process in which the limiting value is set to a smaller value (a process in which the width in the lateral direction of the determination region is narrowed), the lateral position of the object 60 is outside the determination region range (outside the limiting value), and this may interrupt activation of the safety unit.

According to the present embodiment, therefore, in order to determine whether the own vehicle 40 is turning, the traveling state calculation section 12 of the driving assist ECU 10 uses a steering angle of the own vehicle 40, in addition to the yaw rate differential value, for determining whether the own vehicle 40 is turning. In this case, the traveling state calculation section 12 functions as steering information acquisition means (second acquisition means). Specifically, the traveling state calculation section 12 acquires, as steering information, a steering angle which is a detection value detected by the steering angle sensor 25. The traveling state calculation section 12 determines, on the basis of the steering information thus acquired and a predetermined threshold (determination criterion value), whether the own vehicle 40 is turning. In the case where an absolute value of the steering angle is not less than a second threshold, the traveling state calculation section 12 determines that the own vehicle 40 has started turning (is in the turning state). That is, the traveling state calculation section 12 uses a result of the determination of whether the steering unit 33 has been operated by the driver, for determining whether the own vehicle 40 is in the turning state. Thus, in order to increase accuracy in determination of whether the own vehicle 40 is in the turning state, the driving assist ECU 10 in accordance with the present embodiment is configured such that in the case where the absolute value of the yaw rate differential value is not less than the first threshold and the absolute value of the steering angle is not less than the second threshold, the own vehicle 40 is determined to be in the turning state.

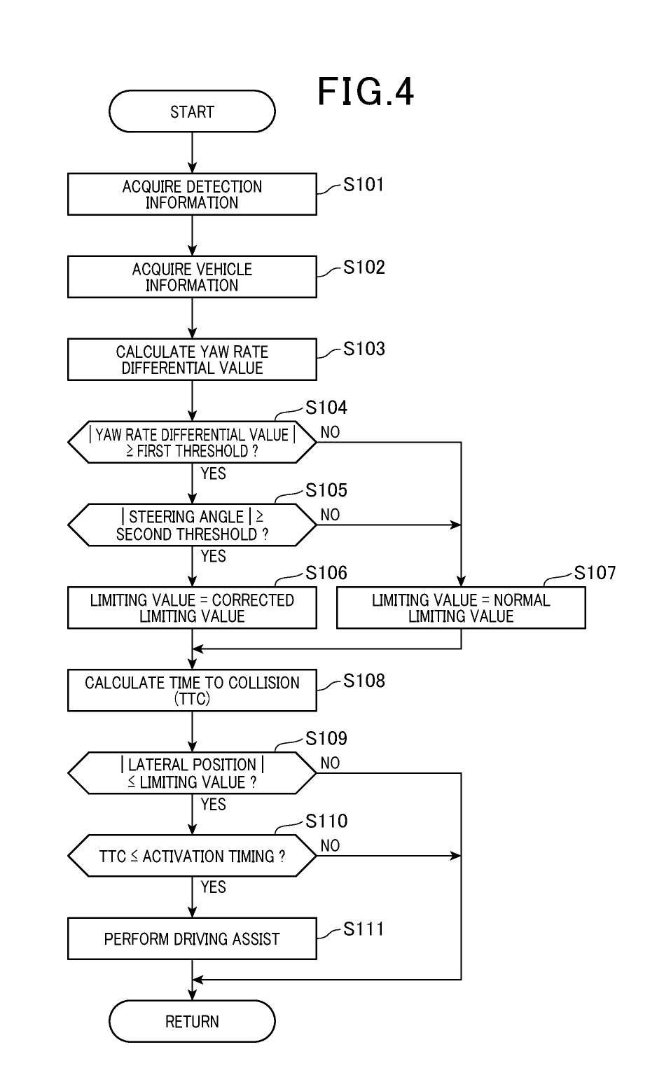

With reference to FIG. 4, the following description will discuss a series of processes which is performed by the driving assist ECU 10 in accordance with the present embodiment. The processes shown in FIG. 4 are performed, for each predetermined control cycle, with respect to each object 60 which is present ahead of the traveling direction of the own vehicle 40.

First, the driving assist ECU 10 acquires detection information (a detection value of a position) from the radar apparatus 21 and the image capturing device 22 (S101). The driving assist ECU 10 acquires vehicle information (detection values of a vehicle speed, a yaw rate, and a steering angle) from the vehicle speed sensor 23, the yaw rate sensor 24, and the steering angle sensor 25 (S102). Subsequently, the driving assist ECU 10 calculates a yaw rate differential value on the basis of the yaw rate which is a detection value detected by the yaw rate sensor 24 (S103). The driving assist ECU 10 determines whether an absolute value of the yaw rate differential value thus calculated is not less than the first threshold (S104). In the case where the driving assist ECU 10 has determined that the absolute value of the yaw rate differential value is not less than the first threshold (S104: YES), the driving assist ECU 10 determines whether an absolute value of the steering angle is not less than the second threshold (S105). In the case where the driving assist ECU 10 has determined that the absolute value of the steering angle is not less than the second threshold (S105: YES), the driving assist ECU 10 determines that the own vehicle 40 is in the turning state. Consequently, the driving assist ECU 10 sets the corrected limiting value as the limiting value (S106). That is, the driving assist ECU 10 sets, as the limiting value (limiting value for the determination region) for determining whether the object 60 is present on the traveling course of the own vehicle 40, the corrected limiting value which is smaller than the reference value for determination. Meanwhile, in the case where the driving assist ECU 10 has determined that the absolute value of the yaw rate differential value is less than the first threshold (S104: NO), the driving assist ECU 10 determines that the own vehicle 40 is not in the turning state. Similarly, in the case where the driving assist ECU 10 has determined that the absolute value of the steering angle is less than the second threshold (S105: NO), the driving assist ECU 10 determines that the own vehicle 40 is not in the turning state. Consequently, the driving assist ECU 10 sets the normal limiting value as the limiting value (S107). That is, the driving assist ECU 10 sets, as the limiting value for determining whether the object 60 is present on the traveling course of the own vehicle 40, the normal limiting value which is the reference value for determination.

Subsequently, the driving assist ECU 10 calculates, on the basis of the detection information, time to collision (TTC) which is time until the own vehicle 40 collides with the object 60 (S108). The driving assist ECU 10 determines, on the basis of the detection information, whether a lateral position of the object 60 is within a range of the limiting value (in the determination region) (S109). In this case, the driving assist ECU 10 determines whether an absolute value of the lateral position of the object 60 is not more than the limiting value which has been set. Consequently, in the case where the driving assist ECU 10 has determined that the lateral position of the object 60 is within the range of the limiting value (S109: YES), there is a possibility that the object 60 is present on the traveling course of the own vehicle 40 in the time to collision (TTC). Accordingly, in order to avoid a collision with the object 60, the driving assist ECU 10 determines whether the time to collision (TTC) has reached the activation timing of the safety unit (S110). In this case, the driving assist ECU 10 determines whether the time to collision (TTC) has exceeded a set time for the activation timing of the safety unit. Consequently, in the case where the driving assist ECU 10 has determined that the time to collision (TTC) has reached the activation timing of the safety unit (S110: YES), the driving assist ECU 10 activates the safety unit so that driving assistance for avoiding a collision risk is provided (S111). Then, the series of processes are ended.

In the case where the driving assist ECU 10 has determined that the lateral position of the object 60 is outside the range of the limiting value (S109: NO), the driving assist ECU 10 terminates the series of processes without activating the safety unit. Similarly, also in the case where the driving assist ECU 10 has determined that the time to collision (TTC) has not reached the activation timing of the safety unit (S110: NO), the driving assist ECU 10 causes the series of processes to be ended without activating the safety unit.

The aforementioned configuration of the vehicle control apparatus (driving assist ECU 10) in accordance with the present embodiment brings about the following effects.

In the case where either one of the yaw rate information or the steering information is used to determine whether there is a possibility that the own vehicle 40 will collide with the object 60 which is located ahead of the traveling direction of the own vehicle 40, erroneous determination may occur. In the case where the yaw rate information is used, it may be erroneously detected, due to behavior of the vehicle or the like, that the own vehicle 40 is in the turning state even though the own vehicle 40 is in the straight traveling state. Meanwhile, in the case where the steering information is used, it may be erroneously detected, due to fluctuation of steering or the like, that the own vehicle 40 is in the turning state even though the own vehicle 40 is in the straight traveling state. According to the vehicle control apparatus in accordance with the present embodiment, therefore, in the case where a value of the yaw rate information is greater than the first threshold and a value of the steering information is greater than the second threshold (in the case where the own vehicle 40 is in the turning state), the width of the determination region for determining whether the object 60 is present on the traveling course of the own vehicle 40 is narrowed. Thus, according to the vehicle control apparatus in accordance with the present embodiment, the object 60 is decided as not being in the determination region so that the object 60 is not determined to be present on the traveling course of the own vehicle 40. This causes the safety unit to be less likely to be activated. This consequently allows the vehicle control apparatus in accordance with the present embodiment to increase accuracy in determination of (accurately determine) whether to activate the safety unit.

The yaw rate differential value is calculated on the basis of the detection value detected by the yaw rate sensor 24 (a parameter based on behavior of the vehicle). A value of the steering angle is calculated on the basis of the detection value detected by the steering angle sensor 25 (a parameter based on a steering operation of the steering unit 33). Thus, the vehicle control apparatus in accordance with the present embodiment determines, on the basis of a plurality of parameters which are detected in different manners, whether the own vehicle 40 is in the turning state. This allows the vehicle control apparatus in accordance with the present embodiment to increase accuracy in determination of the turning state of the own vehicle 40.

### Second Embodiment

According to the first embodiment, the determination region (region for determining whether the object 60 is present on the traveling course of the own vehicle 40) based on the rightward limiting value XR and the leftward limiting value XL is set to be ahead of the traveling direction of the own vehicle 40. According to the first embodiment, on the basis of a determination result of whether the object 60 is located in the determination region which has been set, it is determined whether there is a possibility that the own vehicle 40 will collide with the object 60. Meanwhile, according to the present embodiment, a movement locus of the object 60 is predicted and a collision lateral position which is a position at which the object 60 is predicted to collide with the own vehicle 40 is calculated. According to the present embodiment, it is then determined whether the collision lateral position thus calculated is in the determination region based on the rightward limiting value XR and the leftward limiting value XL. According to the present embodiment, it is thus determined whether there is a possibility that the own vehicle 40 will collide with the object 60.

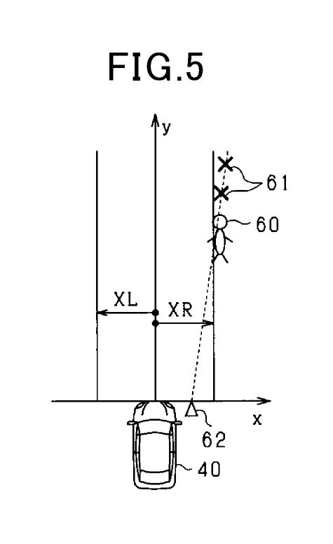

With reference to FIG. 5, the following description will discuss the activation determination section 14 of the driving assist ECU 10 which is the vehicle control apparatus in accordance with the present embodiment. Specifically, the following description will discuss a determination process (a determination process for determining whether to activate the safety unit) which is performed by the activation determination section 14. The rightward limiting value XR and the leftward limiting value XL in accordance with the present embodiment are similar to those of the first embodiment, and thus, descriptions of these limiting values will be omitted. In the following descriptions, members having functions same as those of the members illustrated in the figures used in the foregoing descriptions are given the same reference numerals and descriptions of such members will be omitted. The driving assist ECU 10 in accordance with the present embodiment stores, over a predetermined time period, a previous position 61 (longitudinal position and lateral position) of the object 60 which has been detected, and records the previous position 61 as a position history of the object 60. The activation determination section 14 estimates a movement locus of the object 60 on the basis of the previous position 61, which has been recorded as the position history, of the object 60 and a current position of the object 60. Then, by assuming that the object 60 moves along the movement locus thus estimated, the activation determination section 14 calculates, as a collision lateral position 62, a lateral position of a point at which a longitudinal position between the front end of the own vehicle 40 and the object 60 is zero.

The activation determination section 14 compares the collision lateral position 62 thus calculated with the rightward limiting value XR and the leftward limiting value XL which define the determination region. Consequently, in the case where the collision lateral position 62 is in the determination region based on the rightward limiting value XR and the leftward limiting value XL, the activation determination section 14 determines that there is a possibility that the own vehicle 40 will collide with the object 60. A process in accordance with the present embodiment to be performed after the activation determination section 14 has determined that there is a possibility that the own vehicle 40 will collide with the object 60 is similar to that of the first embodiment, and thus description of the process will be omitted.

The aforementioned configuration of the vehicle control apparatus (driving assist ECU 10) in accordance with the present embodiment brings about effects equivalent to those of the vehicle control apparatus in accordance with the first embodiment.

### Modified Example

According to the aforementioned embodiments, the steering angle is used, as the steering information, to determine whether the own vehicle 40 is in the turning state. However, the present disclosure is not limited to this. For example, according to a modified example, a steering angle speed which is a value obtained by time-differentiating a value of the steering angle is calculated. According to the modified example, it is then determined whether an absolute value of the steering angle speed thus calculated is not less than a threshold. Consequently, in the case where the absolute value of the steering angle speed is not less than the threshold, the own vehicle 40 is determined to be in the turning state. It is possible to determine in this manner whether the own vehicle 40 is in the turning state. As another modified example, it is possible to determine whether the own vehicle 40 is in the turning state, on the basis of a condition that an absolute value of the steering angle is not less than a threshold and an absolute value of the steering angle speed is not less than a threshold.

According to the aforementioned embodiments, the yaw rate differential value is used, as the yaw rate information, to determine whether the own vehicle 40 is in the turning state. However, the present disclosure is not limited to this. For example, according to the modified example, the yaw rate which is a detection value detected by the yaw rate sensor 24 can be used for the determination.

According to the aforementioned embodiments, in the case where the own vehicle 40 is in the turning state, the limiting value for determining whether the object 60 is present on the traveling course of the own vehicle 40 is changed to a value smaller than the reference value so that the width in the lateral direction of the determination region is narrowed. According to the aforementioned embodiments, this causes the safety unit to be less likely to be activated. Meanwhile, according to the modified example, it is possible to cause the safety unit to be less likely to be activated, by changing the set time so that the activation timing of the safety unit is delayed (by setting the set time for the activation timing to be shorter). As another modified example, it is possible to perform in combination a process for changing the limiting value for the determination region and a process for changing the activation timing of the safety unit.

According to the modified example, the own vehicle 40 can be determined to be in the turning state in the case where it is determined whether a sign indicating a displacement direction of the yaw rate is the same as a sign indicating a displacement direction of the steering angle (whether the signs coincide with each other) and it has been determined that the signs are the same (in the case where the signs coincide with each other). Similarly, according to the modified example, the own vehicle 40 can be determined to be in the turning state in the case where it is determined whether a positive/negative sign of the yaw rate differential value is the same as a positive/negative sign of the steering angle speed and it has been determined that the signs are the same. According to the modified example, therefore, it is possible to accurately determine whether the own vehicle 40 is in the turning state. Thus, according to the modified example, it is possible to cause the safety unit to be less likely to be activated in the case where an absolute value of the yaw rate information is greater than the first threshold and an absolute value of the steering information is greater than the second threshold, and the positive/negative sign of the yaw rate differential value coincides with the positive/negative sign of the steering angle speed. Alternatively, according to the modified example, it is possible to cause the safety unit to be less likely to be activated in the case where the absolute value of the yaw rate information is greater than the first threshold and the absolute value of the steering information is greater than the second threshold, and the sign indicating the displacement direction of the yaw rate coincides with the sign indicating the displacement direction of the steering angle. As another modified example, it is possible to perform in combination a process for determining signs of the yaw rate and the steering angle and a process for determining signs of the yaw rate differential value and the steering angle speed.

As described above, at the time of braking of the own vehicle 40, a value of the yaw rate may be changed by behavior of the vehicle or the like. According to the modified example, therefore, at the time of braking of the own vehicle 40 such as a case where the automatic brake control function of the braking unit 32 has been activated, it is possible to accurately determine whether the own vehicle 40 is in the turning state, by setting at least one of the first threshold and the second threshold to a value greater than a value to be set at the time of non-braking of the own vehicle 40. In this case, the driving assist ECU 10 in accordance with the modified example functions as braking determination means for determining whether the braking unit 32 (braking unit) of the own vehicle 40 has been activated. Accordingly, the driving assist ECU 10 in accordance with the modified example can be configured such that it is determined whether the braking unit 32 of the own vehicle 40 has been activated, and on the basis of a result of the determination, at least one value of the first threshold and the second threshold is changed (is set to a value greater than the value to be set at the time of non-braking of the own vehicle 40).

According to the modified example, it is possible to change at least one of the first threshold and the second threshold on the basis of a speed of the own vehicle 40. In this case, according to the modified example, the traveling state calculation section 12 of the driving assist ECU 10 functions as vehicle speed acquisition means. Accordingly, the driving assist ECU 10 in accordance with the modified example can be configured such that a speed of the own vehicle 40 is acquired, and on the basis of the speed thus acquired, at least one value of the first threshold and the second threshold is changed. A relationship between the speed of the own vehicle 40 and the yaw rate differential value is as below. As the speed of the own vehicle 40 is greater (higher speed), the own vehicle 40 is more unlikely to make a sharp turn. Accordingly, the yaw rate differential value tends to be smaller, as the speed of the own vehicle 40 is greater. The steering angle and the steering angle speed also tend to be smaller, as the speed of the own vehicle 40 is greater. According to the modified example, therefore, as the speed of the own vehicle 40 is greater, it is possible to set at least one of the first threshold and the second threshold to a value smaller than normal. That is, according to the modified example, it is possible to cause the safety unit to be less likely to be activated, by changing the limiting value to a smaller value, as the speed of the own vehicle 40 is greater.

According to the modified example, it is possible to change, on the basis of the yaw rate differential value, the corrected limiting value which is set in the case where the own vehicle 40 has been determined to be in the turning state. For example, in the case where a calculated value of the yaw rate differential value is great, it is possible to estimate that the own vehicle 40 is making a sharp turn. In this case, therefore, it is possible to set, as the corrected limiting value, a value still smaller than a value to be set when the limiting value is normally corrected. That is, according to the modified example, it is possible to cause the safety unit to be less likely to be activated, by changing the limiting value to a smaller value, as the absolute value of the yaw rate information is greater. As another modified example, it is possible to change the corrected limiting value on the basis of a value of the steering angle. Furthermore, it is possible to perform a process for delaying the activation timing of the safety unit more than normal, in the case where a calculated value of the yaw rate differential value is great when the activation timing of the safety unit has been changed so that it is less likely to be determined that the object 60 collides with the own vehicle 40. Similarly, according to the modified example, it is possible to change at least one of the corrected limiting value and the activation timing of the safety unit on the basis of a speed of the own vehicle 40, a relative distance (longitudinal position and lateral position) and a relative speed (longitudinal speed and lateral speed) of the object 60 to the own vehicle 40, or the like.

According to the modified example, it is possible to obtain a yaw rate by detecting wheel speeds of the respective wheels of the own vehicle 40 and calculating the yaw rate on the basis of differences in the detected wheel speeds of the respective wheels.

According to the aforementioned embodiments, the normal limiting value (rightward limiting value XR and leftward limiting value XL) is set on the basis of a type of the object 60. According to the modified example, it is possible to set the corrected limiting value on the basis of a type of the object 60.

In this case, according to the modified example, it is possible to acquire the corrected limiting value from map data stored in a memory. Alternatively, according to the modified example, it is possible to acquire, as the corrected limiting value, a value obtained by subtracting a predetermined correction amount from the normal limiting value.

According to the modified example, the rightward limiting value XR and the leftward limiting value XL each of which is the normal limiting value can be values different from each other. The corrected limiting values in the left and right directions can also be values different from each other.

According to the modified example, it is possible to set a different value, for each function of the safety unit, as at least one of the normal limiting value and the corrected limiting value.

According to the aforementioned embodiments, the notification unit 31, the braking unit 32, and the steering unit 33 are mentioned as the safety unit. However, the safety unit connectable to the vehicle control apparatus of the present disclosure is not limited to these devices.

The aforementioned embodiments have shown an example in which the driving assist ECU 10 functions as the vehicle control apparatus. However, the present disclosure is not limited to this. For example, it is possible to cause the driving assist ECU 10 to function as a turning determination device which performs a process for determining, with use of the yaw rate information and the steering information, whether the own vehicle 40 is in the turning state.

According to the aforementioned embodiments, the vehicle control apparatus is a driving assist system which avoids a collision of the own vehicle 40 with an object which is located ahead of the own vehicle 40. However, the vehicle control apparatus of the present disclosure is not limited to this. The vehicle control apparatus of the present disclosure is applicable to, for example, a driving assist system which detects an object located behind of the own vehicle 40 and avoids a collision of the own vehicle 40 with the object thus detected. The vehicle control apparatus of the present disclosure is also applicable to a driving assist system which avoids a collision of the own vehicle 40 with an object which is approaching the own vehicle 40. Note that the phrase “ahead of the traveling direction,” which has been used in the descriptions of the aforementioned embodiments, means “ahead of the own vehicle 40,” in the case where the own vehicle 40 is traveling forward. Meanwhile, in the case where the own vehicle 40 is traveling backward, the phrase means “to the rear of the own vehicle 40.”

The own vehicle 40 equipped with the vehicle control apparatus of the present disclosure is not limited to a vehicle which is driven by a human who rides in the vehicle. The vehicle control apparatus of the present disclosure is similarly applicable to, for example, a vehicle which is automatically driven by an ECU for control or the like.

### REFERENCE SIGNS LIST

10: Driving assist ECU, 11: Object recognition section, 12: Traveling state calculation section, 13: Limiting value calculation section, 14: Activation determination section, 15: Control processing section, 21: Radar apparatus, 22: Image capturing device, 23: Vehicle speed sensor, 24: Yaw rate sensor, 25: Steering angle sensor, 31: Notification unit, 32: Braking unit, 33: Steering unit.

1. A vehicle control apparatus comprising:
a position acquisition means for acquiring a relative position of an object to an own vehicle, the object being located ahead of the own vehicle in a traveling direction;
a yaw rate information acquisition means for acquiring yaw rate information including at least one value of a yaw rate of the own vehicle and a yaw rate differential value which is a time differential value of the yaw rate;
a steering information acquisition means for acquiring steering information including at least one value of a steering angle of the own vehicle and a steering angle speed which is a time differential value of the steering angle; and
an avoidance control means for activating, on a basis of the relative position, a safety unit for avoiding a collision with the object, the safety unit being provided in the own vehicle,
in the case where an absolute value of the yaw rate information is greater than a first threshold and an absolute value of the steering information is greater than a second threshold, the avoidance control means causing the safety unit to be less likely to be activated.

2. The vehicle control apparatus according to claim 1 wherein:
the yaw rate information includes the yaw rate differential value;
the steering information includes the steering angle speed; and
in the case where the absolute value of the yaw rate information is greater than the first threshold and the absolute value of the steering information is greater than the second threshold, and a positive/negative sign of the yaw rate differential value coincides with a positive/negative sign of the steering angle speed, the avoidance control means causes the safety unit to be less likely to be activated.

3. The vehicle control apparatus according to claim 1 wherein:
the yaw rate information includes the yaw rate;
the steering information includes the steering angle; and
in the case where the absolute value of the yaw rate information is greater than the first threshold and the absolute value of the steering information is greater than the second threshold, and a sign indicating a displacement direction of the yaw rate coincides with a sign indicating a displacement direction of the steering angle, the avoidance control means causes the safety unit to be less likely to be activated.

4. The vehicle control apparatus according to claim 1 wherein:
the position acquisition means acquires a lateral position which is the relative position of the object in a lateral direction orthogonal to the traveling direction of the own vehicle;
the avoidance control means sets a limiting value which is a width in the lateral direction, and determines, on a basis of the limiting value and the lateral position, whether to activate the safety unit; and
the avoidance control means causes the safety unit to be less likely to be activated, by changing the limiting value to a smaller value.

5. The vehicle control apparatus according to claim 1 wherein the avoidance control means causes the safety unit to be less likely to be activated, by delaying an activation timing of the safety unit.

6. The vehicle control apparatus according to claim 1 further comprising a vehicle speed acquisition means for acquiring a speed of the own vehicle,
the avoidance control means changing at least one value of the first threshold and the second threshold on a basis of the speed.

7. The vehicle control apparatus according to claim 6 wherein the avoidance control means changes at least one value of the first threshold and the second threshold to a smaller value, as the speed is greater.

8. The vehicle control apparatus according to claim 1 further comprising a vehicle speed acquisition means for acquiring a speed of the own vehicle,
the avoidance control means causing the safety unit to be less likely to be activated, as the speed is greater.

9. The vehicle control apparatus according to claim 1 wherein the avoidance control means causes the safety unit to be less likely to be activated, as the absolute value of the yaw rate information is greater.

10. The vehicle control apparatus according to claim 1 further comprising a collision time prediction means for calculating time to collision which is time until the own vehicle collides with the object,
the position acquisition means acquiring a longitudinal position which is the relative position of the object in the traveling direction of the own vehicle,
the collision time predicting means calculating the time to collision on a basis of a relative speed of the own vehicle and the longitudinal position,
the avoidance control means causing the safety unit to be less likely to be activated, as a value of the time to collision is greater.

11. The vehicle control apparatus according to claim 1 further comprising a braking determination means for determining whether a braking unit of the own vehicle has been activated,
in the case where the braking unit has been activated, the avoidance control means changing at least one value of the first threshold and the second threshold to a greater value.

12. A method of controlling a vehicle which method is performed by a vehicle control apparatus provided in an own vehicle,
the vehicle control apparatus performing the steps of:
acquiring a relative position of an object to the own vehicle, the object being located ahead of the own vehicle in a traveling direction;
acquiring yaw rate information including at least one value of a yaw rate of the own vehicle and a yaw rate differential value which is a time differential value of the yaw rate;
acquiring steering information including at least one value of a steering angle of the own vehicle and a steering angle speed which is a time differential value of the steering angle; and
activating, on a basis of the relative position, a safety unit for avoiding a collision with the object, the safety unit being provided in the own vehicle, wherein
in the activating step, in the case where an absolute value of the yaw rate information is greater than a first threshold and an absolute value of the steering information is greater than a second threshold, the safety unit is caused to be less likely to be activated.

13. A vehicle control apparatus comprising:
a memory;
a processor communicable to the memory; and
a set of computer-executable instructions stored on the memory that cause the processor to implement:
acquiring a relative position of an object to an own vehicle, the object being located ahead of the own vehicle in a traveling direction;
acquiring yaw rate information including at least one value of a yaw rate of the own vehicle and a yaw rate differential value which is a time differential value of the yaw rate;
acquiring steering information including at least one value of a steering angle of the own vehicle and a steering angle speed which is a time differential value of the steering angle; and
activating, on a basis of the relative position, a safety unit for avoiding a collision with the object, the safety unit being provided in the own vehicle,
in the case where an absolute value of the yaw rate information is greater than a first threshold and an absolute value of the steering information is greater than a second threshold, the processor causes the safety unit to be less likely to be activated.
